(19) United States
(12) Patent Application Publication
(10) Pub. No.: US 2025/0289433 A1
(43) Pub. Date: Sep. 18, 2025

(54) VEHICLE CONTROL APPARATUS AND METHOD THEREOF

(71) Applicants: Hyundai Motor Company, Seoul (KR); Kia Corporation, Seoul (KR)

(72) Inventors: Ji Chang Kim, Hwaseong-Si (KR); Heung Seok Chae, Hwaseong-Si (KR); Su Jung Yoo, Hwaseong-si (KR); Yoo Suk Kim, Hwaseong-si (KR)

(21) Appl. No.: 18/794,090

(22) Filed: Aug. 5, 2024

(30) Foreign Application Priority Data
Mar. 15, 2024 (KR) 10-2024-0036655

(51) Int. Cl. B60W 30/18

(52) U.S. Cl. CPC B60W 30/18163; B60W 2420/403; B60W 2554/4041; B60W 2554/802

(57) ABSTRACT

A vehicle control apparatus is disclosed. The vehicle control apparatus includes a sensor device, a memory, and a controller. The vehicle control apparatus identifies a first driving speed of a host vehicle and a second driving speed of at least one other vehicle which travels in an adjacent lane to a lane in which the host vehicle is traveling, while the host vehicle is traveling, determines whether the adjacent lane corresponds to a congestion state using the first driving speed and the second driving speed, and performs biased driving control or lane change control based on at least one of a relative position between the host vehicle and the at least one other vehicle, whether it is possible to make a lane change, or a distance from the host vehicle to an end point of the congestion state, or any combination thereof.

### CROSS-REFERENCE TO RELATED APPLICATIONS

This application claims priority to Korean Patent Application No. 10-2024-0036655, filed in the Korean Intellectual Property Office on Mar. 15, 2024, the entire contents of which are incorporated herein for all purposes.

### TECHNICAL FIELD

The present disclosure relates to a vehicle control apparatus and a method thereof, and more particularly, relates to technologies for adaptively changing a driving strategy depending on a state of an adjacent lane.

### BACKGROUND

As autonomous driving control technology and/or semi-autonomous driving control (or cruise driving) technology are/is being developed, stable driving technology for a host vehicle may gradually become more sophisticated. For example, if identifying a situation in which there is a need for deceleration driving, biased driving, and/or lane change while performing driving control for the host vehicle, it is necessary to develop various algorithms to perform and/or implement a driving strategy based on various conditions of the identified situation.

An autonomous driving system may generate (or establish) a driving strategy for the host vehicle with regard to a driving state (e.g., a driving speed, acceleration, a driving direction, or the like) of the host vehicle, a surrounding situation (e.g., a situation of an adjacent lane) of the host vehicle. For example, the autonomous driving system may perform autonomous driving control through recognition, determination, path generation, and vehicle control steps.

The autonomous driving system may identify a situation in which it is determined to reduce a driving speed of the host vehicle. For example, if checking that other vehicles are traveling at a speed smaller than the host vehicle in a lane adjacent to the lane in which the host vehicle is traveling (e.g., a left lane and/or a right lane of the lane), the autonomous driving system may reduce the speed of the host vehicle, thus preventing a situation of collision with the other vehicle which enters the lane of the host vehicle from the adjacent lane.

According to at least some technologies, the driving speed of the host vehicle is uniformly reduced, if the congestion state of the adjacent lane is identified. Such a driving strategy causes a user to feel uncomfortable.

### SUMMARY

One or more features of the present disclosure has been made to solve the above-mentioned problems.

An aspect of the present disclosure may provide an apparatus (e.g., a vehicle control apparatus). The apparatus may comprise a sensor device; a memory storing at least one instruction; and a controller operatively coupled to the sensor device and the memory. The at least one instruction may be configured to, when executed by the controller, cause the apparatus to: identify a first driving speed of a host vehicle comprising the apparatus; identify, using the sensor device, a second driving speed of at least one other vehicle which travels in an adjacent lane that is adjacent to a lane in which the host vehicle is traveling; determine, based on the first driving speed and the second driving speed, whether the adjacent lane corresponds to a congestion state; and while the adjacent lane corresponds to the congestion state, perform biased driving control or lane change control based on at least one of: a relative position between the host vehicle and the at least one other vehicle, a determination whether it is possible to make a lane change, or a distance from the host vehicle to an end point of the congestion state.

An aspect of the present disclosure may provide a vehicle control apparatus for selectively using lane change control and/or biased driving control, for example, based on at least one of a relative position between a host vehicle and at least one other vehicle in an adjacent lane, whether it is possible to make a lane change, a distance from the host vehicle to an end point of a congestion state, and/or any combination thereof to perform autonomous driving control according to a stable and small-discomfort driving strategy and a method thereof.

Another aspect of the present disclosure may provide a vehicle control apparatus that may cluster at least one other vehicle which may be traveling in an adjacent lane, for example, based on a driving speed and/or a separation distance of each of the other vehicles. It may perform lane change control, deceleration, and biased driving control using at least one segment generated, for example, based on the clustered result and/or a method thereof.

Another aspect of the present disclosure may provide a vehicle control apparatus that may cluster at least one other vehicle which may be traveling in an adjacent lane into at least one segment based on a driving speed and a separation distance of each of the at least one other vehicle. It may establish a driving strategy based on an average driving speed for each segment to perform autonomous driving control with higher accuracy and more suitably matched with an actual situation, compared to an algorithm that may establish a driving strategy based on an average driving speed for the entire adjacent lane and/or a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control apparatus may include a sensor device, a memory storing at least one instruction, and/or a controller operatively connected with the sensor device and the memory. For example, the at least one instruction may be configured to, if executed by the controller, cause the vehicle control apparatus to identify a first driving speed of a host vehicle and/or a second driving speed of at least one other vehicle which may travel in an adjacent lane to a lane in which the host vehicle may be traveling, using the sensor device, while the host vehicle may be traveling, determine whether the adjacent lane may correspond to a congestion state using the first driving speed and the second driving speed, and perform biased driving control or lane change control based on at least one of a relative position between the host vehicle and the at least one other vehicle, whether it is possible to make a lane change, or a distance from the host vehicle to an end point of the congestion state, or any combination thereof, if it is determined that the adjacent lane corresponds to the congestion state.

According to an example, the at least one instruction may be configured to, if executed by the controller, cause the vehicle control apparatus to identify external objects included in an area by a first distance in front of the host vehicle and a second distance behind the host vehicle in the adjacent lane, using the sensor device, identify at least one object, in which a share for the adjacent lane is greater than or equal to a specified rate and a difference in movement speed with other objects is within a specified range, among the external objects as the at least one other vehicle, and identify the second driving speed of the identified at least one other vehicle.

According to an example, the at least one instruction may be configured to, if executed by the controller, cause the vehicle control apparatus to identify a first area where a left line in a right lane of the lane is substantially the same as a right line of the lane as the adjacent lane, if there is the right lane of the lane and identify a second area where a right line in a left lane of the lane is substantially the same as a left line of the lane as the adjacent lane, if there is the left lane of the lane.

According to an example, the at least one instruction may be configured to, if executed by the controller, cause the vehicle control apparatus to perform clustering based on a speed of each of the at least one other vehicle and a separation distance between the at least one other vehicle to identify at least one segment and further use an average speed of each of the at least one segment to determine whether the adjacent lane corresponds to the congestion state.

According to an example, the at least one instruction may be configured to, if executed by the controller, cause the vehicle control apparatus to, if one cluster is identified as a result of performing the clustering, identify a point corresponding to a first distance in front of the host vehicle in the adjacent lane as an end point of a segment corresponding to the cluster and identify a point corresponding to a second distance behind the host vehicle in the adjacent lane as a starting point of the segment corresponding to the cluster.

According to an example, the at least one instruction may be configured to, if executed by the controller, cause the vehicle control apparatus to, if a plurality of clusters are identified as a result of performing the clustering, identify a point closer to the host vehicle between a first point of the adjacent lane, the first point corresponding to a first distance in front of the host vehicle, and a second point of a frontmost vehicle included in the plurality of clusters as an end point of a plurality of segments respectively corresponding to the plurality of clusters and identify a point further away from the host vehicle between a third point of the adjacent lane, the third point corresponding to a second distance behind the host vehicle, and a fourth point of a rearmost vehicle included in the plurality of clusters as a starting point of the plurality of segments respectively corresponding to the plurality of clusters.

According to an example, the at least one instruction may be configured to, if executed by the controller, cause the vehicle control apparatus to determine that the adjacent lane corresponds to the congestion state, if the second driving speed is maintained during a first time or more in a state in which the second driving speed is smaller than a value obtained by subtracting a specified value from the first driving speed.

According to an example, the at least one instruction may be configured to, if executed by the controller, cause the vehicle control apparatus to, if it is identified that there is a merging section or a diverging section within a specified distance in front of the adjacent lane, determine that the adjacent lane corresponds to the congestion state, if the second driving speed is maintained during a second time or more in the state in which the second driving speed is smaller than the value obtained by subtracting the specified value from the first driving speed. For example, the second time may be smaller than the first time.

According to an example, the at least one instruction may be configured to, if executed by the controller, cause the vehicle control apparatus to identify an average driving speed for each of the plurality of segments, determine that the adjacent lane corresponds to the congestion state, if a specified segment in which the average driving speed is maintained during a first time or more in a state in which the average driving speed is smaller than a value obtained by subtracting a specified value from the first driving speed is identified, and perform the lane change control to an opposite lane to the adjacent lane, if there is the host vehicle behind a starting point of the specified segment.

According to an example, the at least one instruction may be configured to, if executed by the controller, cause the vehicle control apparatus to decelerate the host vehicle based on an average driving speed of the specified segment, if it is determined that it is impossible to perform the lane change control to the opposite lane, and perform the biased driving control in a direction opposite to the adjacent lane.

According to an example, the at least one instruction may be configured to, if executed by the controller, cause the vehicle control apparatus to identify an average driving speed for each of the plurality of segments, determine that the adjacent lane corresponds to the congestion state, if a specified segment in which the average driving speed is maintained during a first time or more in a state in which the average driving speed is smaller than a value obtained by subtracting a specified value from the first driving speed is identified, identify a distance from the host vehicle to an end point of the specified segment, if there is the host vehicle in front of a starting point of the specified segment, and perform the biased driving control or the lane change control, based on the result of comparing the distance to the end point with a threshold distance.

According to an example, the at least one instruction may be configured to, if executed by the controller, cause the vehicle control apparatus to decelerate the host vehicle based on an average driving speed of the specified segment and perform the biased driving control in a direction opposite to the adjacent lane, if the distance to the end point is less than or equal to the threshold distance, and perform the lane change control to an opposite lane to the adjacent lane, if the distance to the end point is greater than the threshold distance.

According to an example, the at least one instruction may be configured to, if executed by the controller, cause the vehicle control apparatus to perform deceleration driving control for the host vehicle based on an average driving speed according to the congestion state, if both of a left lane and a right lane of the lane in the adjacent lane correspond to the congestion state or if it is determined that it is impossible to perform the lane change control.

According to another aspect of the present disclosure, a vehicle control method may include identifying, by a controller, a first driving speed of a host vehicle and a second driving speed of at least one other vehicle which travels in an adjacent lane to a lane in which the host vehicle is traveling, using a sensor device, while the host vehicle is traveling, determining, by the controller, whether the adjacent lane corresponds to a congestion state using the first driving speed and the second driving speed, and performing, by the controller, biased driving control or lane change control based on at least one of a relative position between the host vehicle and the at least one other vehicle, whether it is possible to make a lane change, or a distance from the host vehicle to an end point of the congestion state, or any combination thereof, if it is determined that the adjacent lane corresponds to the congestion state.

According to an example, the vehicle control method may further include identifying, by the controller, external objects included in an area by a first distance in front of the host vehicle and a second distance behind the host vehicle in the adjacent lane, using the sensor device, identifying, by the controller, at least one object, in which a share for the adjacent lane is greater than or equal to a specified rate and a difference in movement speed with other objects is within a specified range, among the external objects as the at least one other vehicle, and identifying, by the controller, the second driving speed of the identified at least one other vehicle.

According to an example, the vehicle control method may further include identifying, by the controller, a first area where a left line in a right lane of the lane is substantially the same as a right line of the lane as the adjacent lane, if there is the right lane of the lane, and identifying, by the controller, a second area where a right line in a left lane of the lane is substantially the same as a left line of the lane as the adjacent lane, if there is the left lane of the lane.

According to an example, the vehicle control method may further include performing, by the controller, clustering based on a speed of each of the at least one other vehicle and a separation distance between the at least one other vehicle to identify at least one segment and further using, by the controller, an average speed of each of the at least one segment to determine whether the adjacent lane corresponds to the congestion state.

According to an example, the vehicle control method may further include, if one cluster is identified as a result of performing the clustering, identifying, by the controller, a point corresponding to a first distance in front of the host vehicle in the adjacent lane as an end point of a segment corresponding to the cluster and identifying, by the controller, a point corresponding to a second distance behind the host vehicle in the adjacent lane as a starting point of the segment corresponding to the cluster.

According to an example, the vehicle control method may further include, if a plurality of clusters are identified as a result performing the clustering, identifying, by the controller, a point closer to the host vehicle between a first point of the adjacent lane, the first point corresponding to a first distance in front of the host vehicle, and a second point of a frontmost vehicle included in the plurality of clusters as an end point of a plurality of segments respectively corresponding to the plurality of clusters and identifying, by the controller, a point further away from the host vehicle between a third point of the adjacent lane, the third point corresponding to a second distance behind the host vehicle, and a fourth point of a rearmost vehicle included in the plurality of clusters as a starting point of the plurality of segments respectively corresponding to the plurality of clusters.

According to an example, the vehicle control method may further include determining, by the controller, that the adjacent lane corresponds to the congestion state, if the second driving speed is maintained during a first time or more in a state in which the second driving speed is smaller than a value obtained by subtracting a specified value from the first driving speed.

One or more other aspects of the apparatuses and methods described herein may be implemented in the above apparatuses and methods.

### BRIEF DESCRIPTION OF THE DRAWINGS

The above and other objects, features and advantages of the present disclosure will be more apparent from the following detailed description taken in conjunction with the accompanying drawings.

FIG. 1 shows an example of components of a vehicle control apparatus according to an example of the present disclosure.

FIG. 2 shows an example of a conceptual diagram showing components and an operation of a vehicle control apparatus according to an example of the present disclosure.

FIG. 3 shows an example of a conceptual diagram showing a criterion for determining an adjacent lane in a vehicle control apparatus according to an example of the present disclosure.

FIG. 4 shows an example of a conceptual diagram showing a situation in which a vehicle control apparatus determines a congestion state of an adjacent lane according to an example of the present disclosure.

FIG. 5 shows an example of a conceptual diagram showing an operation of generating at least one segment through clustering in a vehicle control apparatus according to an example of the present disclosure.

FIG. 6 shows an example of a conceptual diagram showing an operation of establishing a driving strategy in a vehicle control apparatus according to an example of the present disclosure.

FIG. 7 shows an example of a flowchart of a vehicle control method according to an example of the present disclosure.

FIG. 8 shows an example of a flowchart of a vehicle control method according to an example of the present disclosure.

FIG. 9 shows an example of a computing system about a vehicle control apparatus or a vehicle control method according to an example of the present disclosure.

With regard to description of drawings, the same or similar denotations may be used for the same or similar components.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even if they are displayed on other drawings. Additionally or alternatively, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

An autonomous driving vehicle may encounter different types of roads, for example, such as highways, city streets, rural roads, residential streets, mountain roads, gravel or dirt roads, expressways, toll roads, bridges and overpasses, tunnels, etc.

An autonomous driving vehicle may use road data for autonomous driving. For example, a high density (HD) map may include various road data necessary for autonomous driving, which may include, for example, lanes (e.g., a number and orientation of lanes), traffic lights (e.g., location and status of traffic lights), signs (e.g., location and status of road signs), road conditions (e.g., potholes, bumps, road texture), traffic flow (e.g., traffic density, speeds, patterns), obstacles and hazard information (e.g., construction zones, debris, pedestrians), location of crosswalks and pedestrian paths, layouts of intersections, and roadside features (e.g., barriers, guardrails, sidewalks, edges).

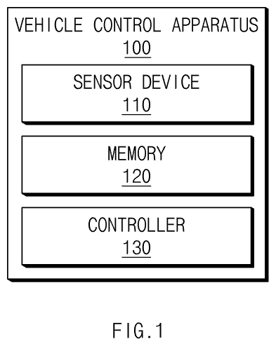

Hereinafter, examples of the present disclosure may be described in detail with reference to FIGS. 1 to 9.

FIG. 1 shows an example of components of a vehicle control apparatus according to an example of the present disclosure.

According to an example, a vehicle control apparatus 100 may include a sensor device 110, a memory 120, and/or a controller 130. The components of the vehicle control apparatus 100 (shown in FIG. 1) are illustrative, and examples of the present disclosure are not limited thereto. For example, the vehicle control apparatus 100 may further comprise components (e.g., at least one of a communication device, an interface, a display, or a notification device, or any combination thereof) which are not shown in FIG. 1. Any information that may be obtained by or sent to the vehicle control apparatus 100 may be used by a host device described herein.

According to an example, the sensor device 110 may obtain (or identify) various pieces of information that may be used to control driving of a host vehicle.

For example, the sensor device 110 may comprise at least one sensor comprising at least one of a camera, radio detection and ranging (RADAR), light detection and ranging (LiDAR), and/or any combination thereof.

For example, the sensor device 110 may obtain information about an external object (e.g., at least one of a person, another vehicle, a building, a structure, or a combination thereof), using the at least one sensor.

For example, the sensor device 110 may obtain information about a driving environment of the host vehicle. For example, the sensor device 110 may obtain information about at least one of a driving speed of the host vehicle, acceleration of the host vehicle, a driving direction of the host vehicle, and/or any combination thereof.

For example, the sensor device 110 may obtain information about a lane in which the host vehicle is traveling and information about an adjacent lane adjacent to the lane of the host vehicle. As an example, the adjacent lane may include a left lane and/or a right lane of the lane. The sensor device 110 may obtain, for example, information about a line of the lane and a line of the left lane and the right lane. The controller 130 may identify, for example, a range (or an area) of the adjacent lane using the information about the line.

For example, the sensor device 110 may obtain information about whether there is at least one other vehicle and/or a driving state of the at least one other vehicle (e.g., at least one of a driving speed of the at least one other vehicle, acceleration of the at least one other vehicle, a driving direction of the at least one other vehicle, a separation distance from the host vehicle, a separation distance of each of the at least one other vehicle, or whether the at least one other vehicle is stopped, or a combination thereof).

As an example, the sensor device 110 may identify a driving speed of each of the at least one other vehicle which is traveling in a lane (e.g., a left lane and/or a right lane) next to the lane in which the host vehicle is traveling. The sensor device 110 may obtain, for example, a separation distance between the at least one other vehicle. The sensor device 110 may obtain a share for a lane of each of the at least one other vehicle. As an example, the share for the lane may be a ratio of a vehicle included in both lines of the lane.

According to an example, the memory 120 may store a command or data. For example, the memory 120 may store one or more instructions, if executed by the controller 130, causing the vehicle control apparatus 100 to perform various operations.

For example, the memory 120 and the controller 130 may be implemented as one chipset. The controller 130 may include at least one of a communication processor or a modem.

For example, the memory 120 may store various pieces of information associated with the vehicle control apparatus 100. As an example, the memory 120 may store information about an operation history of the controller 130. As an example, the memory 120 may store information associated with states and/or operations of components (e.g., at least one of an engine control unit (ECU), the sensor device 110, or the controller 130, or any combination thereof) of the host vehicle.

For example, the memory 120 may include different types of a plurality of storage devices. For example, the memory 120 may include at least one of a random-access memory (RAM) or an embedded multi-media card (eMMC), or any combination thereof.

As an example, the RAM may temporarily store data (e.g., driving data) about an operation of the autonomous control apparatus 110 and/or the host vehicle which is a control target of the autonomous control apparatus 100. The RAM may include, for example, at least one buffer. The autonomous control apparatus 100 may store, for example, at least one node divided by dividing pieces of data collected (or identified) while performing autonomous driving control for the host vehicle by a unit time in the RAM.

As an example, the eMMC may include a built-in multimedia card. The eMMC may store, for example, data for a longer time than the RAM. The eMMC may be implemented as, for example, a separate memory chip independent of the RAM.

According to an example, the controller 130 may be operatively connected with the memory 120. For example, the controller 130 may control an operation of the memory 120.

For example, while the host vehicle is traveling, the controller 130 may identify a first driving speed of the host vehicle and a second driving speed of at least one other vehicle which travels in an adjacent lane to the lane in which the host vehicle is traveling, using the sensor device 110.

As an example, the controller 130 may identify the first driving speed corresponding to a real-time driving speed of the host vehicle which is traveling on the lane using the sensor device 110.

For example, the controller 130 may identify the second driving speed of the at least one other vehicle which travels in the adjacent lane to the lane (e.g., one area of a left lane and/or a right lane of the lane) using the sensor device 110. The second driving speed may be, for example, an average value of driving speeds of other vehicles in a segment generated by clustering some of at least one other vehicle.

As an example, the controller 130 may first identify an external object included in an area to a first distance in front of the host vehicle and an area to a second distance behind the host vehicle, in the adjacent lane. For example, the controller 130 may determine a congestion state using only at least one external object included in an area by the first distance in front of the assumed position of the host vehicle and the second distance behind the assumed position of the host vehicle, after assuming that the host vehicle laterally moves to the adjacent lane, among external objects included in the adjacent lane.

As an example, the controller 130 may identify at least one object in which a share for the adjacent lane is greater than or equal to a specified rate and a difference in movement speed with other objects is within a specified range among the identified external objects as at least one other vehicle for determining the congestion state. For example, the controller 130 may identify only an object in which a rate at which there is a shape (or body) of an object among the identified external objects within the adjacent lane is greater than or equal to the specified rate as the at least one other vehicle. For example, the controller 130 may exclude an object in which a difference in movement speed with other objects is out of a predefined range among the identified at least one other vehicle from the at least one other vehicle for determining the congestion state.

As an example, the controller 130 may identify the second driving speed of the identified at least one other vehicle based on the above-mentioned example. The second driving speed may be, for example, an average speed of other vehicles in a segment generated by clustering the at least one other vehicle based on a driving speed and a separation distance of each of the at least one other vehicle.

For example, the controller 130 may divide and identify a range of the adjacent lane using line information of the lane.

As an example, if there is a right lane of the lane, the controller 130 may identify a first area where a left line in the right lane is substantially the same as a right line of the lane as the adjacent lane.

As an example, if there is a left lane of the lane, the controller 130 may identify a second area where a right line in the left lane is substantially the same as a left line of the lane as the adjacent lane.

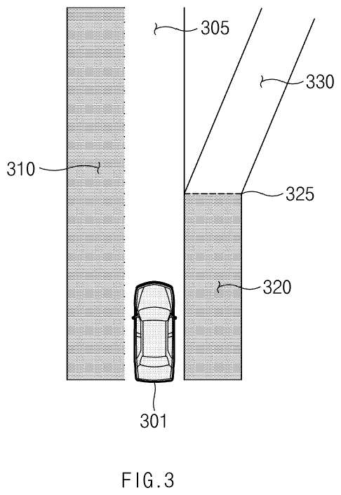

The description of the example in which the controller 130 divides and identifies the range of the adjacent lane may be disclosed in detail in a description of FIG. 3 to be described below.

For example, the controller 130 may determine whether the adjacent lane corresponds to the congestion state using the first driving speed and the second driving speed.

As an example, the controller 130 may perform clustering based on a speed of each of the at least one other vehicle and a separation distance between the at least one other vehicle to identify at least one segment.

For example, the controller 130 may divide and identify other vehicles, each of which has a driving speed within a specified range (or within a similar range), among the at least one other vehicle as one cluster. For example, the controller 130 may divide and identify other vehicles, each of which has a separation distance between a forward other vehicle and a rear other vehicle within a specified separation distance, among the at least one other vehicle as one cluster.

For example, the controller 130 may identify at least one segment respectively corresponding to the divided clusters. For example, the controller 130 may further use an average speed of each of the at least one segment to determine whether the adjacent lane corresponds to the congestion state. For example, the controller 130 may determine whether the adjacent lane corresponds to the congestion state, using the average speed of each of the at least one segment, which is included in the second driving speed of the at least one other vehicle.

As an example, if one cluster is identified as a result of performing clustering, the controller 130 may identify a point corresponding to the first distance in front of the host vehicle in the adjacent lane as an end point of the segment corresponding to the cluster.

As an example, if one cluster is identified as a result of performing clustering, the controller 130 may identify a point corresponding to the second distance behind the host vehicle in the adjacent lane as a starting point of the segment corresponding to the cluster.

As an example, the controller 130 may identify a point closer to the host vehicle between a first point of the adjacent lane, which corresponds to the first distance in front of the host vehicle, and a second point of a frontmost vehicle included in a plurality of clusters as an end point of a plurality of segments respectively corresponding to the plurality of clusters.

As an example, the controller 130 may identify a point further away from the host vehicle between a third point of the adjacent lane, which corresponds to the second distance behind the host vehicle, and a fourth point of a rearmost vehicle included in the plurality of clusters as a starting point of the plurality of segments respectively corresponding to the plurality of clusters.

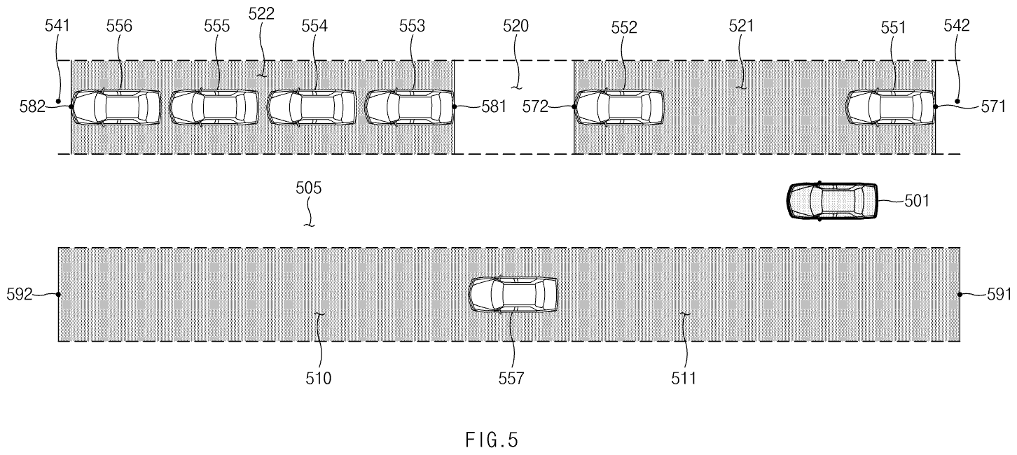

The description of the example of dividing the starting point and the end point of the segment may be disclosed in detail in a description of FIG. 5 to be described below.

For example, if the second driving speed is maintained during a first time or more in a state in which the second driving speed is smaller than a value obtained by subtracting a specified value from the first driving speed, the controller 130 may determine that the adjacent lane corresponds to the congestion state.

For example, if it is identified that there is a merging section or a diverging section within a specified distance in front of the adjacent lane and if the second driving speed is maintained during a second time or more in the state in which the second driving speed is smaller than the value obtained by subtracting the specified value from the first driving speed, the controller 130 may determine that the adjacent lane corresponds to the congestion state. As an example, the second time may be smaller than the first time. For example, if there is a merging section or a diverging section in one area in front of the adjacent lane, the controller 130 may quickly determine whether the adjacent lane corresponds to the congestion state to more quickly establish a driving strategy, thus performing safe and accurate driving control.

For example, if it is determined that the adjacent lane corresponds to the congestion state, the controller 130 may perform biased driving control or lane change control based on at least one of a relative position between the host vehicle and the at least one other vehicle, whether it is possible to make a lane change, or a distance from the host vehicle to the end point of the congestion state, or any combination thereof.

For example, if the plurality of segments are identified in the adjacent lane, the controller 130 may identify an average driving speed of each of the plurality of segments. Thereafter, if a specified segment in which the average driving speed is maintained during the first time in a state in which the average driving speed is smaller than the value obtained by subtracting the specified value from the first driving speed is identified, the controller 130 may determine that the adjacent lane corresponds to the congestion state and may establish a driving strategy depending on the relative position between the host vehicle and the at least one other vehicle (or another vehicle included in the specified segment).

As an example, if there is the host vehicle behind the starting point of the specified segment, the controller 130 may perform lane change control to change the lane of the host vehicle to an opposite lane (e.g., a left lane of the lane) to the adjacent lane (e.g., a right lane of the lane). At this time, if it is determined that it is impossible to perform the lane change control to the opposite lane (e.g., if it is determined that the opposite lane corresponds to the congestion state or a space for a lane change is not identified in the opposite lane), the controller 130 may reduce a driving speed of the host vehicle based on the average driving speed of the specified segment and may perform biased driving control in a direction opposite to the adjacent lane.

As an example, if there is the host vehicle in front of the starting point of the specified segment, the controller 130 may identify a distance from the host vehicle to the end point of the specified segment and may perform biased driving control or lane change control, based on the result of comparing the distance to the end point with a threshold distance. For example, if the distance to the end point is less than or equal to the threshold distance, the controller 130 may decelerate the host vehicle based on the average driving speed of the specified segment and may perform biased driving control in the direction opposite to the adjacent lane. For example, if the distance to the end point is greater than the threshold distance, the controller 130 may perform lane change control to the opposite lane to the adjacent lane. At this time, like the above-mentioned example, if it is determined that it is impossible to perform the lane change control to the opposite lane (e.g., if it is determined that the opposite lane corresponds to the congestion state or the space for the lane change is not identified in the opposite lane), the controller 130 may reduce a driving speed of the host vehicle based on the average driving speed of the specified segment and may perform biased driving control in the direction opposite to the adjacent lane.

For example, if both the left lane and the right lane of the lane among the adjacent lanes correspond to the congestion state or if it is determined that it is impossible to perform the lane change control, the controller 130 may perform deceleration driving control for the host vehicle based on an average driving speed of the left lane and the right lane according to the congestion state. As an example, the controller 130 may decrease the driving speed of the host vehicle to a speed smaller than the average driving speed of the left lane and the right lane.

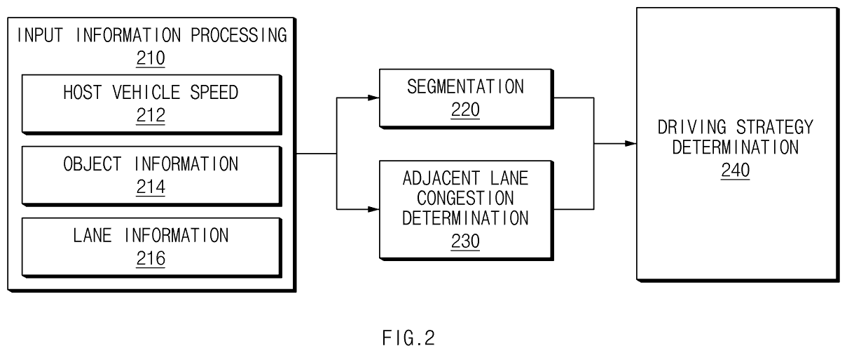

FIG. 2 shows an example of a conceptual diagram showing components and an operation of a vehicle control apparatus according to an example of the present disclosure.

According to an example, a vehicle control apparatus 100 (e.g., a vehicle control apparatus 100 of FIG. 1) may perform input information processing 210, segmentation 220, adjacent lane congestion determination 230, and/or driving strategy determination 240.

For example, the vehicle control apparatus 100 may perform the input information processing 210, for example, by using a sensor device 110 (e.g., a sensor device 110 of FIG. 1).

For example, input information to be processed may include a host vehicle speed 212, object information 214, and/or lane information 216.

For example, the vehicle control apparatus 100 may perform the segmentation 220 and/or the adjacent lane congestion determination 230, for example, based on the result of performing the input information processing 210.

For example, the vehicle control apparatus 100 may cluster one or more other vehicles showing a similar driving pattern to perform the segmentation 220 for generating at least one segment.

For example, the vehicle control apparatus 100 may perform the adjacent lane congestion determination 230, for example, using at least one of an average driving speed of a segment, a relative position between a starting point and an end point of the segment and the host vehicle, or a shape of an adjacent lane, or any combination thereof.

For example, the vehicle control apparatus 100 may perform the driving strategy determination 240.

For example, the vehicle control apparatus 100 may perform lane change control and/or biased driving control, for example, based on the result of performing the segmentation 220 and/or the adjacent lane congestion determination 230. For example, the vehicle control apparatus 100 may reduce the driving speed of the host vehicle, for example, based on the magnitude of the driving speed of the at least one other vehicle in the adjacent lane in the process of performing the lane change control and/or the biased driving control.

FIG. 3 shows an example of a conceptual diagram showing a criterion for determining an adjacent lane in a vehicle control apparatus according to an example of the present disclosure.

According to an example, a vehicle control apparatus (e.g., a vehicle control apparatus 100 of FIG. 1) may identify a lane 305 in which a host vehicle 301 is traveling and may divide and identify an area of an adjacent lane to determine a congestion state.

For example, the vehicle control apparatus 100 may identify an area to be divided into the adjacent lane among areas of a left lane 310 and a right lane 320, based on line information of the lane 305.

For example, if there is the left lane 310 adjacent to the lane 305, the vehicle control apparatus 100 may identify an area where a right line of the left lane 310 is substantially the same as a left line of the lane 305 as the adjacent lane.

For example, as shown in FIG. 3, the vehicle control apparatus 100 may identify the entire area of the left lane 310 as the adjacent lane and may determine whether the area corresponds to the congestion state, for example, because the entire right line of the left lane 310 is substantially the same as the entire left line of the lane 305.

For example, if there is the right lane 320 adjacent to the lane 305, the vehicle control apparatus 100 may identify an area where a left line of the right lane 320 is substantially the same as a right line of the lane 305 as the adjacent lane.

For example, as shown in FIG. 3, the vehicle control apparatus 100 may identify an area to the diverging point 325 within the entire area of the right lane 320 as the adjacent lane and may determine whether the area corresponds to the congestion state, for example, because the left line of the right lane 320 to a diverging point 325 is substantially the same as the right line of the lane 305. Additionally or alternatively, the vehicle control apparatus 100 may determine that a diverging line 330 after the diverging point 325 is not included in the adjacent lane.

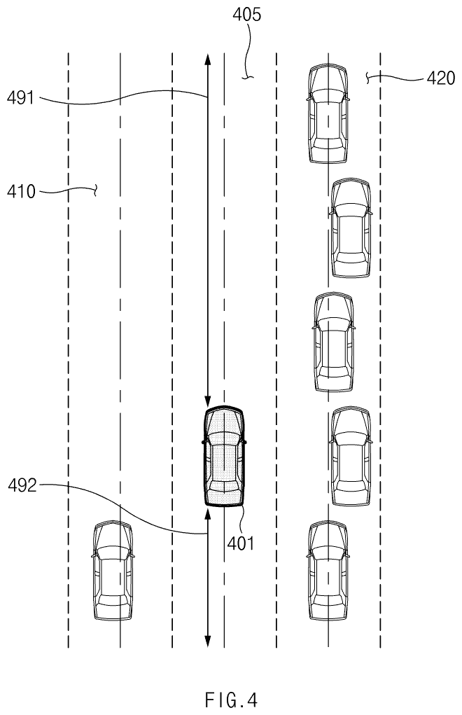

FIG. 4 shows an example of a conceptual diagram showing a situation in which a vehicle control apparatus 100 determines a congestion state of an adjacent lane according to an example of the present disclosure.

According to an example, a vehicle control apparatus (e.g., a vehicle control apparatus 100 of FIG. 1) may identify a lane 405 in which a host vehicle 401 is traveling and may divide and identify a target area of an adjacent lane to determine a congestion state.

For example, the vehicle control apparatus 100 may determine whether there is a congestion state in an adjacent lane using an external object within an area to a first distance 491 in front of the host vehicle 401 and an area to a second distance 492 behind the host vehicle 401, assuming that the host vehicle 401 moves laterally to a left lane 410 of the lane 405, in the left lane 410 of the lane 405.

For example, the vehicle control apparatus 100 may determine whether there is a congestion state in an adjacent lane using an external object within an area to the first distance 491 in front of the host vehicle 401 and an area to the second distance 492 behind the host vehicle 401, assuming that the host vehicle 401 laterally moves to a right lane 420 of the lane, in the right lane 420 of the lane 405.

For example, the vehicle control apparatus 100 may determine whether there is a congestion state in an adjacent lane, using an external object (e.g., 6 other vehicles shown in FIG. 4) included in the area by the first distance 491 in front of the host vehicle 401 and/or the second distance 492 behind the host vehicle 401 in the adjacent lane.

Additionally or alternatively, the vehicle control apparatus 100 may determine whether there is a congestion state in the adjacent lane, using another vehicle in which a share for the adjacent lane (or a rate at which the body of the vehicle is included in the lane) is greater than or equal to a specified rate among the at least one other vehicle included in the adjacent lane. For example, if another vehicle is identified as having a share is less than the specified rate while deviating from the right lane 420 to the right is identified, the vehicle control apparatus 100 may fail to use information about the other vehicle if determining whether there is the congestion state in the adjacent lane.

FIG. 5 shows an example of a conceptual diagram showing an operation of generating at least one segment through clustering in a vehicle control apparatus 100 according to an example of the present disclosure.

According to an example, a vehicle control apparatus (e.g., a vehicle control apparatus 100 of FIG. 1) may identify a lane 505 in which a host vehicle 501 is traveling and may identify at least one segment (511, 521, and/or 522) including at least one other vehicle in an adjacent lane to determine a congestion state.

For example, the vehicle control apparatus 100 may identify the at least one segment (511, 521, and/or 522) included in each of a left lane 510 and a right lane 520 of the lane 505. For example, the vehicle control apparatus 100 may perform clustering, for example, based on a speed of each of the at least one other vehicle and/or a separation distance between the at least one other vehicle to identify the at least one segment (511, 521, and/or 522).

For example, the vehicle control apparatus 100 may divide and/or identify a first other vehicle 551 and/or a second other vehicle 552 which are traveling in the right lane 520 as a first cluster. The vehicle control apparatus 100 may identify the first segment 521 corresponding to the first cluster. For example, the vehicle control apparatus 100 may cluster the first other vehicle 551 and the second other vehicle 552 in which a headway is within a specified range and a difference in driving speed is less than or equal to a specified difference among the first to sixth other vehicles 551, 552, 553, 554, 555, and 556, which are traveling in the right lane 520, to identify the first other vehicle 551 and/or the second other vehicle 552 as the first cluster and may identify the first segment 521 based on a criterion for determining a starting point and an end point of a segment according to the number of clusters in the right lane 520.

For example, the vehicle control apparatus 100 may divide and identify the third other vehicle 553, the fourth other vehicle 554, the fifth other vehicle 555, and the sixth other vehicle 556, which are traveling in the right lane 520, as a second cluster. The vehicle control apparatus 100 may identify the second segment 522 corresponding to the second cluster. For example, the vehicle control apparatus 100 may cluster the third other vehicle 553, the fourth other vehicle 554, the fifth other vehicle 555, and the sixth other vehicle 556, if their headway is within the specified range and a difference in driving speed is less than or equal to the specified difference among the first to sixth other vehicles 551, 552, 553, 554, 555, and 556 which are traveling in the right lane 520 to identify the third other vehicle 553, the fourth other vehicle 554, the fifth other vehicle 555, and the sixth other vehicle 556 as the second cluster and may identify the second segment 522 based on a criterion for determining the starting point and the end point of the segment according to the number of clusters in the right lane 520.

For example, if identifying that an average driving speed of each of the first segment 521 and the second segment 522 is maintained during a first time or more in a state in which the average driving speed of each of the first segment 521 and the second segment 522 is smaller than a value obtained by subtracting a specified value from a driving speed of the host vehicle 501, the vehicle control apparatus 100 may determine that the right lane 520 among the adjacent lanes may correspond to the congestion state.

For example, after checking that the plurality of clusters are identified as a result of performing clustering for the right lane 520, the vehicle control apparatus 100 may identify a starting point and an end point of the segment corresponding to each cluster.

For example, the vehicle control apparatus 100 may identify a second point 572 closer to the host vehicle 501 between a first point 541 of the right lane 520, which may correspond to a first distance in front of the host vehicle 501, and the second point 572 of the second other vehicle 552 which is a frontmost vehicle included in the first cluster as an end point of the first segment 521.

For example, the vehicle control apparatus 100 may identify a fourth point 571 closer to the host vehicle 501 between a third point 542 of the right lane 520, which may correspond to a second distance behind the host vehicle 501, and the fourth point 571 of the first other vehicle 551 which may be a rearmost vehicle included in the first cluster as a starting point of the first segment 521.

For example, the vehicle control apparatus 100 may identify a fifth point 582 closer to the host vehicle 501 between the first point 541 of the right lane 520, which may correspond to the first distance in front of the host vehicle 501, and the fifth point 582 of the sixth other vehicle 556 which is a frontmost vehicle included in the second cluster as an end point of the second segment 522.

For example, the vehicle control apparatus 100 may identify a sixth point 581 closer to the host vehicle 501 between the third point 542 of the right lane 520, which may correspond to the second distance behind the host vehicle 501, and the sixth point 581 of the third other vehicle 553 which may be a rearmost vehicle included in the second cluster as a starting point of the second segment 522.

For example, the vehicle control apparatus 100 may identify the fifth point 582 closer to the host vehicle 501 between the first point 541 of the right lane 520, which may correspond to the first distance in front of the host vehicle 501, and the fifth point 582 of the sixth other vehicle 556 which may be a frontmost vehicle included in the second cluster as the end point of the second segment 522.

For example, the vehicle control apparatus 100 may divide and identify a seventh other vehicle 557 which may be traveling in the left lane 510 as a third cluster. If there is only one vehicle in a cluster, the vehicle control apparatus 100 may identify one segment included in the left lane 510 including the cluster.

For example, after checking that one cluster is identified as a result of performing clustering for the left lane 510, the vehicle control apparatus 100 may identify a starting point and an end point of the third segment 511 corresponding to the one cluster.

For example, the vehicle control apparatus 100 may identify a seventh point 592 corresponding to the first distance in front of the host vehicle 501 in the left lane 510 as an end point of the third segment 511 corresponding to the one cluster.

For example, the vehicle control apparatus 100 may identify am eighth point 591 corresponding to the second distance behind the host vehicle 501 in the left lane 510 as a starting point of the third segment 511 corresponding to the one cluster.

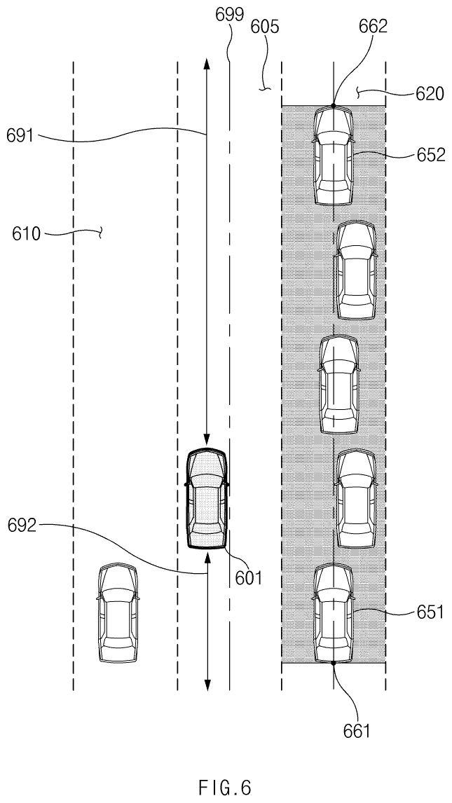

FIG. 6 shows an example of a conceptual diagram showing an operation of establishing a driving strategy in a vehicle control apparatus 100 according to an example of the present disclosure.

According to an example, a vehicle control apparatus (e.g., a vehicle control apparatus 100 of FIG. 1) may identify a lane 605 in which a host vehicle 601 is traveling and may identify at least one segment including at least one other vehicle in an adjacent lane (e.g., a left lane 610 and/or a right lane 620) to determine a congestion state. The description of the example of dividing the starting point and the end point of the segment may be replaced with the description of FIG. 5 described above.

For example, the vehicle control apparatus 100 may identify a left segment included in a left lane 610. Because only one other vehicle is traveling in the left lane 610, the vehicle control apparatus 100 may identify a point corresponding to a first distance 691 (e.g., an end point of the left lane 610 of FIG. 6) in front of the host vehicle 601 in the left lane 610 as an end point of a left segment. Furthermore, the vehicle control apparatus 100 may identify a point corresponding to a second distance 692 (e.g., a starting point of the left lane 610 of FIG. 6) behind the host vehicle 601 in the left lane 610 as a starting point of the left segment.

For example, the vehicle control apparatus 100 may identify a right segment included in the right lane 620. The vehicle control apparatus 100 may determine a starting point and an end point of the right segment depending on a criterion different from the left segment, for example, because five vehicles are traveling in the right lane 620.

Furthermore, the vehicle control apparatus 100 may identify a first point 661 closer to the host vehicle 601 between a point corresponding to a second distance 692 (e.g., a starting point of the right lane 620 of FIG. 6) behind the host vehicle 601 in the right lane 620 and the first point 661 of a rearmost vehicle 651 included in the right cluster as an end point of the right segment.

For example, the vehicle control apparatus 100 may identify a second point 662 closer to the host vehicle 601 between a point corresponding to a first distance 691 (e.g., an end point of the right lane 620 of FIG. 6) in front of the host vehicle 601 in the right lane 620 and the second point 662 of a frontmost vehicle 652 included in the right cluster as an end point of the right segment.

For example, if the average driving speed of the right segment is maintained during a first time or more in a state in which the average driving speed of the right segment is smaller than a value obtained by subtracting a specified value from the driving speed of the host vehicle 601, the vehicle control apparatus 100 may determine that the right lane 620 may correspond to the congestion state. The vehicle control apparatus 100 may control the host vehicle 601, for example, based on lane change control and/or biased driving control.

For example, as shown in FIG. 6, the vehicle control apparatus 100 may identify a distance from the host vehicle 601 to the second point 662 which is the end point of the right segment, for example, because there is the host vehicle 601 in front of the first point 661 which is the starting point of the right segment.

For example, as shown in FIG. 6, if the identified distance is less than or equal to a threshold distance, the vehicle control apparatus 100 may decelerate the host vehicle 601 based on the average driving speed of the right segment and may perform biased driving control in a direction opposite to the right lane 620 (e.g., a direction facing the left lane 610). In FIG. 6, the vehicle control apparatus 100 may check the host vehicle 601 which may be performing biased driving to the left with respect to a centerline 699 of the lane 605.

For example, unlike that shown in FIG. 6, if the identified distance is greater than the threshold distance, the vehicle control apparatus 100 may perform lane change control to the left lane 610 which may be an opposite lane to the right lane 620. At this time, if it is impossible to perform the lane change control and/or it is determined that the left lane 610 also may correspond to the congestion state, the vehicle control apparatus 100 may perform only deceleration driving control. The amount of deceleration for deceleration driving control may be inversely proportional to a magnitude of a driving speed of another vehicle.

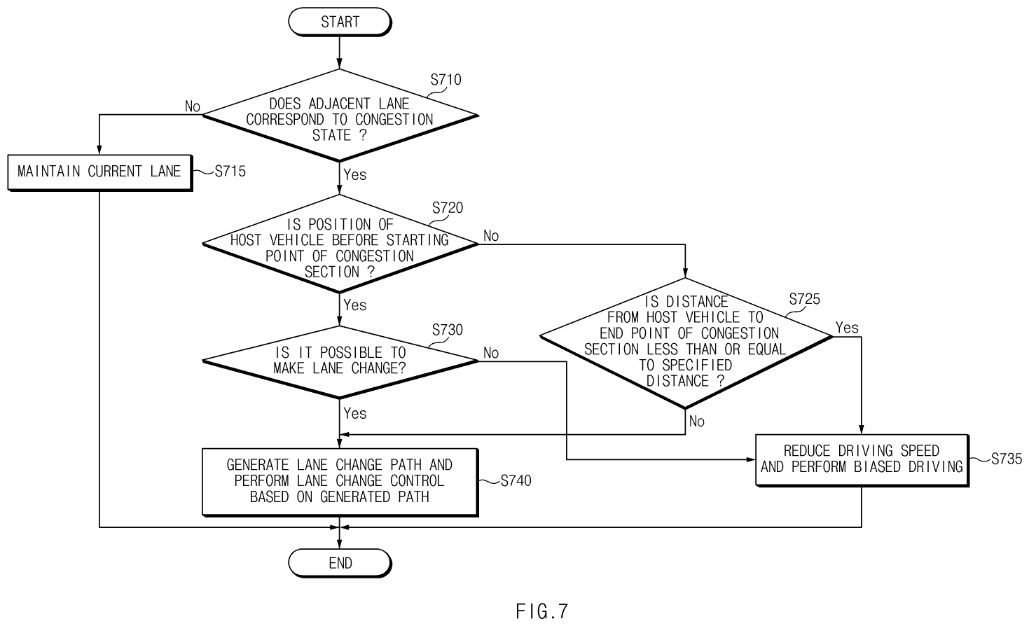

FIG. 7 shows and example of a flowchart of a vehicle control method according to an example of the present disclosure.

According to an example, a vehicle control apparatus (e.g., a vehicle control apparatus 100 of FIG. 1) may perform operations disclosed in FIG. 7. For example, at least some of components (e.g., a sensor device 110, a memory 120, and/or a controller 130 of FIG. 1) that may be included in the vehicle control apparatus 100 may be configured to perform operations of FIG. 7.

Operations in S710 to S740 in an example below may be sequentially performed, but may not be necessarily sequentially performed. For example, an order of the respective operations may be changed, and at least two operations may be performed in parallel. Furthermore, contents, which may correspond to or are duplicated with the contents described above in conjunction with FIG. 7, may be briefly described or omitted.

According to an example, in S710, the vehicle control apparatus 100 may determine whether an adjacent lane may correspond to a congestion state.

For example, the vehicle control apparatus 100 may determine whether the adjacent lane may correspond to the congestion state, for example, based on a driving speed of a host vehicle, an average driving speed of each segment included in the adjacent lane, a difference between the driving speed and the average driving speed, a maintenance time of the difference, and/or the like.

For example, if the adjacent lane corresponds to the congestion state (e.g., S710—Yes), the vehicle control apparatus 100 may perform S720.

For example, if the adjacent lane does not correspond to the congestion state (e.g., S710—No), the vehicle control apparatus 100 may perform S715.

According to an example, in S715, the vehicle control apparatus 100 may maintain a current lane.

For example, the vehicle control apparatus 100 may determine that the adjacent lane may correspond to a normal driving state and may maintain and perform driving control for the host vehicle in the current lane.

According to an example, in S720, the vehicle control apparatus 100 may determine whether the position of the host vehicle may be before a starting point of a congestion section.

For example, if the position of the host vehicle is before the starting point of the congestion section (e.g., S720—Yes), the vehicle control apparatus 100 may perform S730.

For example, if the position of the host vehicle is behind the starting point of the congestion section (e.g., S720—No), the vehicle control apparatus 100 may perform S725.

According to an example, in S730, the vehicle control apparatus 100 may determine whether it may be possible to make a lane change.

For example, if the host vehicle continues traveling in the lane, the vehicle control apparatus 100 may determine that possibility of risk occurrence is high, if another vehicle enters the lane of the host vehicle from an adjacent lane, and may determine whether it is possible to make a lane change to an opposite lane to the adjacent lane. At this time, the vehicle control apparatus 100 may determine whether there is a space for making a lane change to the opposite lane, a driving speed of another vehicle which may be traveling in the opposite lane, or the like.

For example, if it is possible to make the lane change (e.g., S730—Yes), the vehicle control apparatus 100 may perform S740.

For example, if it is impossible to make the lane change (e.g., S730—No), the vehicle control apparatus 100 may perform S735.

According to an example, in S725, the vehicle control apparatus 100 may identify whether a distance from the host vehicle to the end point of the congestion section is less than or equal to a specified distance.

For example, the vehicle control apparatus 100 may determine whether a distance from the host vehicle to an end point of a segment corresponding to the congestion section is less than or equal to a threshold distance.

For example, if the distance from the host vehicle to the end point of the congestion section is less than or equal to the specified distance (e.g., S725—Yes), the vehicle control apparatus 100 may perform S735.

For example, if the distance from the host vehicle to the end point of the congestion section is greater than the specified distance (e.g., S730—No), the vehicle control apparatus 100 may perform S740.

According to an example, in S735, the vehicle control apparatus 100 may reduce a driving speed and may perform biased driving.

For example, the vehicle control apparatus 100 may determine that the host vehicle may relatively quickly pass through the congestion section in the adjacent lane and may perform only deceleration driving control and biased driving control without performing lane change control.

According to an example, in S740, the vehicle control apparatus 100 may generate a lane change path and may perform lane change control based on the generated path.

For example, the vehicle control apparatus 100 may change a driving direction of the host vehicle to an opposite lane to the determined adjacent lane.

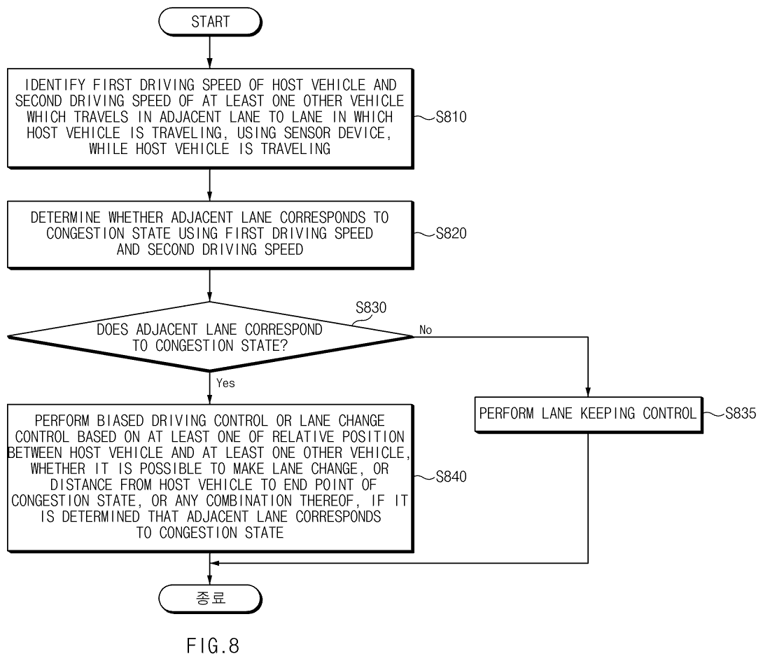

FIG. 8 shows and example of a flowchart of a vehicle control method according to an example of the present disclosure.

According to an example, a vehicle control apparatus (e.g., a vehicle control apparatus 100 of FIG. 1) may perform operations disclosed in FIG. 8. For example, at least some of components (e.g., a sensor device 110, a memory 120, and/or a controller 130 of FIG. 1) that may be included in the vehicle control apparatus 100 may be configured to perform operations of FIG. 8.

Operations in S810 to S840 in an example below may be sequentially performed, but may not be necessarily sequentially performed. For example, an order of the respective operations may be changed, and at least two operations may be performed in parallel. Furthermore, contents, which may correspond to or are duplicated with the contents described above in conjunction with FIG. 8, may be briefly described or omitted.

According to an example, in S810, the vehicle control apparatus 100 may identify a first driving speed of a host vehicle and a second driving speed of at least one other vehicle which may travel in an adjacent lane to the lane in which the host vehicle is traveling, using a sensor device, while the host vehicle is traveling.

According to an example, in S820, the vehicle control apparatus 100 may determine whether the adjacent lane may correspond to a congestion state using the first driving speed and the second driving speed.

According to an example, in S830, the vehicle control apparatus 100 may determine whether the adjacent lane may correspond to the congestion state.

For example, if the adjacent lane corresponds to the congestion state (e.g., S830—Yes), the vehicle control apparatus 100 may perform S840.

For example, if the adjacent lane does not correspond to the congestion state (e.g., S830—No), the vehicle control apparatus 100 may perform S835.

According to an example, in S835, the vehicle control apparatus 100 may perform lane keeping control.

According to an example, in S840, the vehicle control apparatus 100 may perform biased driving control and/or lane change control, for example, based on at least one of a relative position between the host vehicle and at least one other vehicle, whether it is possible to make a lane change, or a distance from the host vehicle to an end point of the congestion state, and/or any combination thereof, for example, if it is determined that the adjacent lane may correspond to the congestion state.

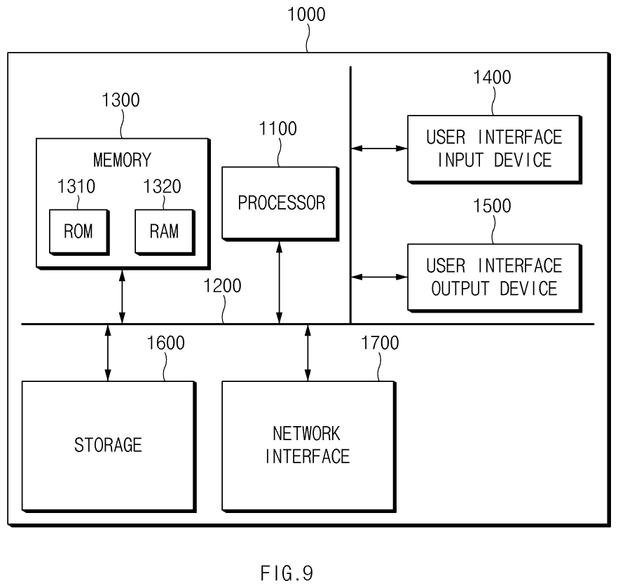

FIG. 9 shows an example of a computing system about a vehicle control apparatus 100 or a vehicle control method according to an example of the present disclosure.

As described with respect to FIG. 9, a computing system 1000 may comprise at least one processor 1100, a memory 1300, a user interface input device 1400, a user interface output device 1500, a storage 1600, and/or a network interface 1700, which may be connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

The operations of the methods and/or algorithms described in connection with the examples disclosed in the present disclosure may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM).

The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

A description will be given of effects of the vehicle control apparatus 100 and the method thereof according to an example of the present disclosure.

Example of the present disclosure may selectively use lane change control or biased driving control based on at least one of a relative position between a host vehicle and at least one other vehicle in an adjacent lane, whether it is possible to make a lane change, or a distance from the host vehicle to an end point of a congestion state, or any combination thereof, thus performing autonomous driving control according to a stable and small-discomfort driving strategy.

Example of the present disclosure may cluster the at least one other vehicle which is traveling in the adjacent lane based on a driving speed or a separation distance of each of the other vehicles and may perform lane change control or deceleration and biased driving control using at least one segment generated based on the clustered result.

Example of the present disclosure may suitably cluster at least one other vehicle which is traveling in an adjacent lane into at least one segment based on a driving speed and a separation distance of each of the at least one other vehicle and may establish a driving strategy based on an average driving speed for each segment, thus performing autonomous driving control with relatively higher accuracy and more suitably matched with an actual situation than an algorithm for establishing a driving strategy based on an average driving speed for the entire adjacent lane.

Additionally or alternatively, various effects ascertained directly or indirectly through the present disclosure may be provided.

Hereinabove, although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus, comprising:
a sensor device;
a memory storing at least one instruction; and
a controller operatively coupled to the sensor device and the memory,
wherein the at least one instruction is configured to, when executed by the controller, cause the apparatus to:
identify a first driving speed of a host vehicle comprising the apparatus;
identify, using the sensor device, a second driving speed of at least one other vehicle which travels in an adjacent lane that is adjacent to a lane in which the host vehicle is traveling;
determine, based on the first driving speed and the second driving speed, whether the adjacent lane corresponds to a congestion state; and
while the adjacent lane corresponds to the congestion state, perform biased driving control or lane change control based on at least one of:
a relative position between the host vehicle and the at least one other vehicle,
a determination whether it is possible to make a lane change, or
a distance from the host vehicle to an end point of the congestion state.

2. The apparatus of claim 1, wherein the at least one instruction is configured to, when executed by the controller, cause the apparatus to:
identify, using the sensor device, external objects included in an area, in the adjacent lane, that is distanced by a first distance in front of the host vehicle and that is distanced by a second distance behind the host vehicle;
identify at least one object, in which a share for the adjacent lane is greater than or equal to a specified rate and a difference in movement speed with other objects is within a specified range, among the external objects as the at least one other vehicle; and
identify the second driving speed of the identified at least one other vehicle.

3. The apparatus of claim 1, wherein the at least one instruction is configured to, when executed by the controller, cause the apparatus to:
identify, based on an identification of a right lane of the lane, a first area where a left line in the right lane of the lane is substantially the same as a right line of the lane as the adjacent lane; or
identify, based on an identification of a left lane of the lane, a second area where a right line in the left lane of the lane is substantially the same as a left line of the lane as the adjacent lane.

4. The apparatus of claim 1, wherein the at least one instruction is configured to, when executed by the controller, cause the apparatus to:
perform clustering based on a speed of each of the at least one other vehicle and a separation distance between the at least one other vehicle to identify at least one segment; and
further use an average speed of each of the at least one segment to determine whether the adjacent lane corresponds to the congestion state.

5. The apparatus of claim 4, wherein the at least one instruction is configured to, when executed by the controller, cause the apparatus to:
identify a point corresponding to a first distance in front of the host vehicle in the adjacent lane as an end point of a segment corresponding to an identified cluster; and
identify a point corresponding to a second distance behind the host vehicle in the adjacent lane as a starting point of the segment corresponding to the identified cluster.

6. The apparatus of claim 4, wherein the at least one instruction is configured to, when executed by the controller, cause the apparatus to:
identify a point closer to the host vehicle, between a first point of the adjacent lane and a second point of a frontmost vehicle included in a plurality of identified clusters, as an end point of a plurality of segments respectively corresponding to the plurality of identified clusters, wherein the first point corresponds to a first distance in front of the host vehicle; and
identify a point further away from the host vehicle, between a third point of the adjacent lane and a fourth point of a rearmost vehicle included in the plurality of identified clusters, as a starting point of the plurality of segments respectively corresponding to the plurality of identified clusters, wherein the third point corresponds to a second distance behind the host vehicle.

7. The apparatus of claim 1, wherein the at least one instruction is configured to, when executed by the controller, cause the apparatus to:
determine that the adjacent lane corresponds to the congestion state, based on the second driving speed being maintained during a first time or more in a state in which the second driving speed is smaller than a value obtained by subtracting a specified value from the first driving speed.

8. The apparatus of claim 7, wherein the at least one instruction is configured to, when executed by the controller, cause the apparatus to:
identify a merging section or a diverging section within a specified distance in front of the adjacent lane; and
determine that the adjacent lane corresponds to the congestion state, based on the second driving speed being maintained during a second time or more in the state in which the second driving speed is smaller than the value obtained by subtracting the specified value from the first driving speed,
wherein the second time is smaller than the first time.

9. The apparatus of claim 6, wherein the at least one instruction is configured to, when executed by the controller, cause the apparatus to:
identify an average driving speed for each of the plurality of segments;
determine that the adjacent lane corresponds to the congestion state, based on a specified segment in which the average driving speed is maintained during a first time or more in a state in which the average driving speed is smaller than a value obtained by subtracting a specified value from the first driving speed; and
perform the lane change control to an opposite lane to the adjacent lane, when the host vehicle is behind a starting point of the specified segment.

10. The apparatus of claim 9, wherein the at least one instruction is configured to, when executed by the controller, cause the apparatus to:
after a determination that it is impossible to perform the lane change control to the opposite lane, decelerate the host vehicle based on an average driving speed of the specified segment; and
perform the biased driving control in a direction opposite to the adjacent lane.

11. The apparatus of claim 6, wherein the at least one instruction is configured to, when executed by the controller, cause the apparatus to:
identify an average driving speed for each of the plurality of segments;
determine that the adjacent lane corresponds to the congestion state, based on a specified segment in which the average driving speed is maintained during a first time or more in a state in which the average driving speed is smaller than a value obtained by subtracting a specified value from the first driving speed;
identify a distance from the host vehicle to an end point of the specified segment, when the host vehicle is in front of a starting point of the specified segment; and
perform the biased driving control or the lane change control, based on a comparison of the distance to the end point with a threshold distance.

12. The apparatus of claim 11, wherein the at least one instruction is configured to, when executed by the controller, cause the apparatus to:
decelerate the host vehicle based on an average driving speed of the specified segment and perform the biased driving control in a direction opposite to the adjacent lane, based on the distance to the end point being less than or equal to the threshold distance; or
perform the lane change control to an opposite lane to the adjacent lane, based on the distance to the end point being greater than the threshold distance.

13. The apparatus of claim 1, wherein the at least one instruction is configured to, when executed by the controller, cause the apparatus to:
perform deceleration driving control for the host vehicle based on an average driving speed according to the congestion state, after a determination that both of a left lane and a right lane of the lane correspond to the congestion state or a determination that it is impossible to perform the lane change control.

14. A vehicle control method, comprising:
identifying, by a controller, a first driving speed of a host vehicle comprising the controller;
identifying, by the controller and using a sensor device, a second driving speed of at least one other vehicle which travels in an adjacent lane that is adjacent to a lane in which the host vehicle is traveling;
determining, by the controller and based on the first driving speed and the second driving speed, whether the adjacent lane corresponds to a congestion state; and
while the adjacent lane corresponds to the congestion state, performing, by the controller, biased driving control or lane change control based on at least one of:
a relative position between the host vehicle and the at least one other vehicle,
a determination whether it is possible to make a lane change, or
a distance from the host vehicle to an end point of the congestion state.

15. The vehicle control method of claim 14, further comprising:
identifying, by the controller and using the sensor device, external objects included in an area, in the adjacent lane, that is distanced by a first distance in front of the host vehicle and that is distanced by a second distance behind the host vehicle in the adjacent lane;
identifying, by the controller, at least one object, in which a share for the adjacent lane is greater than or equal to a specified rate and a difference in movement speed with other objects is within a specified range, among the external objects as the at least one other vehicle; and
identifying, by the controller, the second driving speed of the identified at least one other vehicle.

16. The vehicle control method of claim 14, further comprising:
identifying, by the controller and based on an identification of a right lane of the lane, a first area where a left line in the right lane of the lane is substantially the same as a right line of the lane as the adjacent lane; or
identifying, by the controller and based on an identification of a left lane of the lane, a second area where a right line in the left lane of the lane is substantially the same as a left line of the lane as the adjacent lane.

17. The vehicle control method of claim 14, further comprising:
performing, by the controller, clustering based on a speed of each of the at least one other vehicle and a separation distance between the at least one other vehicle to identify at least one segment; and
further using, by the controller, an average speed of each of the at least one segment to determine whether the adjacent lane corresponds to the congestion state.

18. The vehicle control method of claim 17, further comprising:
identifying, by the controller, a point corresponding to a first distance in front of the host vehicle in the adjacent lane as an end point of a segment corresponding to an identified cluster; and
identifying, by the controller, a point corresponding to a second distance behind the host vehicle in the adjacent lane as a starting point of the segment corresponding to the identified cluster.

19. The vehicle control method of claim 17, further comprising:
identifying, by the controller, a point closer to the host vehicle, between a first point of the adjacent lane and a second point of a frontmost vehicle included in a plurality of identified clusters, as an end point of a plurality of segments respectively corresponding to the plurality of identified clusters, wherein the first point corresponds to a first distance in front of the host vehicle; and
identifying, by the controller, a point further away from the host vehicle, between a third point of the adjacent lane and a fourth point of a rearmost vehicle included in the plurality of identified clusters, as a starting point of the plurality of segments respectively corresponding to the plurality of identified clusters, wherein the third point corresponds to a second distance behind the host vehicle.

20. The vehicle control method of claim 14, further comprising:
determining, by the controller, that the adjacent lane corresponds to the congestion state, based on the second driving speed being maintained during a first time or more in a state in which the second driving speed is smaller than a value obtained by subtracting a specified value from the first driving speed.
